(19) United States
(12) Patent Application Publication
(10) Pub. No.: US 2017/0187050 A1
(43) Pub. Date: Jun. 29, 2017

(54) FUEL CELL UNIT INCLUDING AN EXCHANGEABLE DEIONIZATION DEVICE AND A VEHICLE INCLUDING SUCH A FUEL CELL UNIT

(71) Applicant: Volkswagen AG, Wolfsburg (DE)

(72) Inventors: Peter WEISSBERGER, Gross Twuelpstedt (DE); Oliver BERGER, Braunschweig (DE)

(73) Assignee: Volkswagen AG, Wolfsburg (DE)

(21) Appl. No.: 15/324,303

(22) PCT Filed: Jun. 22, 2015
(86) PCT No.: PCT/EP2015/063966

§ 371 Date: Jan. 6, 2017

(30) Foreign Application Priority Data
Jul. 7, 2014 (DE) 10 2014 213 105.7

(51) Int. Cl. H01M 8/04044; B01D 15/36; B01D 29/11; H01M 8/04029

(52) U.S. Cl. CPC H01M 8/04044; H01M 8/04029; B01D 15/361; B01D 29/114; H01M 2250/20

(57) ABSTRACT

A fuel cell unit having at least one fuel cell, a cooling circuit and a deionization device (10). The deionization device includes a housing (16) and a deionizing agent (11) located therein A vehicle is also provided having such a fuel cell unit. It is provided that the deionization device (10) can be or is connected in a fluid-conveying manner to the cooling circuit (5) with a single connection unit (15) via a flow inlet (13) and a flow outlet (14).

The present invention relates to a fuel cell unit including at least one fuel cell, a cooling circuit and a deionization device which is connected to the cooling circuit, and to a vehicle including such a fuel cell unit.

### BACKGROUND

Fuel cells are devices in which a fuel such as, for example, methanol, ethanol, hydrogen or suitable mixtures thereof, may be burned in a controlled manner with an oxidant such as, for example, pure oxygen, air, chlorine gas or bromine gas, the reaction energy released thereby being converted into electrical energy. Fuel cells of this type have been used for several decades for generating electrical energy. Due to the high efficiency of fuel cells, their low or completely absent pollutant emission, and their low noise generation during operation, interest in the use of fuel cells has sharply increased in many areas in recent years. The vehicle and power plant sectors are such areas worth mentioning in particular.

Fuel cells are typically classified according to the type of electrolyte which separates the anode and cathode chambers from each other. A fuel cell type of particular interest, which is suitable for use, in particular, in smaller power plants and for mobile use (for example, as an energy source for the electric motor vehicle drive), is the polymer electrolyte fuel cell. In the case of this type of fuel cell, an ion-conducting membrane is utilized as the electrolyte. A single solid polymer fuel cell generally includes a so-called membrane electrode assembly (MEA), in the case of which an ion-conducting membrane is situated between a cathode and an anode. The ion-conducting membrane is simultaneously used, in this case, as a partition wall and as an electrolyte. Catalyst particles, which promote the conversion reactions in the fuel cell, are situated on the boundary surface between the electrodes and the membrane. The electrodes are typically in contact with porous current collectors which also stabilize the electrode structure and provide for a supply of fuel and combustion agents. Since the operating voltage of a single cell is normally less than 1 volt, most fuel cells are made up of a cell stack, in which numerous stacked individual cells are connected in series in order to generate a higher voltage.

Since the electrochemical reaction between the fuel and the combustion agents is an exothermic reaction, the fuel cell usually must be cooled, so that the desired operating temperature is maintained and damage to the membrane may be avoided. Since a relatively large amount of heat must be dissipated despite a low temperature difference with respect to the ambient temperature, liquid coolants which have a sufficiently high heat capacity are typically utilized. Aqueous coolants are therefore very highly suitable. Generally, mixtures of water and ethylene glycol are utilized as antifreeze fluids of the kind which are known for cooling internal combustion engines. In order to prevent corrosion of metallic components of the cooling circuit and the fuel cell, the coolants generally also contain non-ionic corrosion inhibitors.

An essential particularity of fuel cell cooling is the requirement of a very low electrical conductivity of the coolant, in order to counter the risk of electrical short circuits between the individual cells of the fuel cell stack. For this purpose, a coolant formed from deionized water, glycol and non-ionic corrosion inhibitors and other additives is utilized.

If deionized water is used as the coolant, this may be simultaneously used for wetting the reactants flowing into the fuel cell, in order to ensure sufficient hydration of the polymer membrane. Depending on the operating conditions, it may be necessary to add an antifreeze fluid, such as, for example, ethylene glycol, or other additives to the cooling water. Due to the materials used in the cooling system and in the fuel cell, however, ions are introduced into the coolant and increase its electrical conductivity. Deionization devices which have ion exchange resins and around which the coolant flows are utilized in order to counteract this effect. The ion exchange resins absorb the ions (cations and anions) dissolved in the coolant and release H³⁰ - and OH⁻-ions which recombine to form H₂O.

From U.S. Pat. No. 5,200,278 or WO 00/17951 A1, for example, it is known to situate filters including solid ion exchange resins in the cooling circuit, so that the aqueous coolant is returned, largely deionized, into the fuel cell stack.

Deionization devices of this type are situated in the flow of the cooling circuit, so that the coolant flows into the deionization device at a first connection unit, passes through the ion exchange resin, and flows back out of the deionization device at a second connection unit.

### SUMMARY OF THE INVENTION

The capacity of the ion exchange resins is limited, and therefore the ion exchange resins must be exchanged at regular replacement intervals. So far, this has required a great deal of maintenance work and has generated high costs, since the entire deionization device must be disconnected from the cooling circuit at both connection units. The deionization device is subsequently emptied and refilled.

Particular precautions must be taken with the ion exchange resin, due to its irritating properties and the classification as a hazardous substance. In the case of the approaches known so far, contact by the user with the resin has not been ruled out, which means that appropriate safety equipment and disposal are necessary.

It is an object of the present invention to provide a fuel cell unit which includes a deionization device for coolants and which may be maintained by using substantially simplified, and shortened work steps.

The present invention therefore relates to a fuel cell unit including at least one fuel cell, a cooling circuit and a deionization device including a housing and a deionizing agent situated therein. According to the present invention, the deionization device is or may be connected to the cooling circuit in a fluid-conveying manner via a flow inlet and a flow outlet with the aid of a single connection unit.

According to the present invention, the deionization device is therefore not situated directly in the cooling circuit, but is rather connected thereto via the connection unit. The connection unit according to the present invention is schematically comparable to a T-connection piece, the connection unit being connected upstream and downstream to the cooling circuit in a fluid-conveying manner and has a fluid-conveying connection at a third outlet, to the deionization device, the third outlet of the T-piece accommodating the flow inlet and the flow outlet to the deionization device. If coolant from the cooling circuit enters the connection unit, upstream, via a flow inlet, the coolant is conveyed into the deionization device. Within the deionization device, the coolant is deionized and undergoes a reversal of its flow direction, so that the coolant is conveyed back into the connection unit and, finally, is conveyed out of the connection unit via the fluid outlet, upstream from the connection unit, into the cooling circuit.

In contrast to the conventional deionization units which are situated directly in the main flow passage of the cooling circuit of the fuel cell, the deionization unit according to the present invention is connected to the cooling circuit via only one single connection, for example, a flange, within the connection unit. If the deionization device is disconnected from the cooling circuit for the purpose of maintenance, cleaning, replacement or regeneration, this takes place at the flange of the connection unit, without the need to disassemble or interrupt the cooling circuit itself. It is therefore no longer required to remove the deionizing agent from the deionization device, to replace the deionizing agent, and to subsequently reinstall the same deionization device into the cooling circuit. Rather, the deionization device may be replaced by a deionization device which is compatible with the corresponding flange part on the connection unit.

The potential risk of the user coming into contact with the deionizing agent is therefore advantageously reduced. In addition, the resultant design having only one connection unit is more compact and requires a less complex tube system.

The connection, according to the present invention, of the deionization device to the cooling circuit with the aid of a single connection unit may be implemented particularly easily by situating a flow inlet and a flow outlet for a coolant on the same side of the housing of the deionization device.

For this purpose, the housing of the deionization device is preferably designed as a vessel, which is open on one side, and may be connected or is connected to the connection unit via the open side. In this way, the housing requires a single connection area which interacts with the connection unit in order to establish a tight and fluid-conveying connection. The housing may be designed, for example, in the form of a hollow cylinder which is open on one side and has a round, oval or rectangular cross-sectional area, preferably a round cross-sectional area. In this case, the open end face is equipped with a connection piece (for example, a flange) which establishes the connection to the connection unit. The length and the diameter of the cross section of the housing may be designed in a variable way and decisively determine the intake capacity of deionizing agent. The housing is made of metal or plastic, in particular, preferably of a metal.

During the maintenance of the fuel cell unit, the deionization device is removed and replaced by a fresh deionization device which may deviate from the ionization device to be replaced in terms of the shape, length and/or diameter of the housing. This is made possible by way of the arrangement of the deionization device in the cooling circuit being primarily determined by the connection between the deionization device and the connection unit. The variation of the deionization device in terms of the shape and size thereof makes a scalability of the deionization device possible, in particular with respect to the ion load of the coolant, which depends on the system control, for example.

In one preferred embodiment of the present invention, the connection between the connection unit and the deionization device, in particular its housing, is designed as a plug connection and/or a rotary joint. Connections of this type offer the advantage that a fluid-conveying and outwardly sealed connection between the connection unit and the deionization device is formed and may be disconnected and reconnected easily, in particular without the use of special tools.

It is particularly preferred when the connection between the connection unit and the deionization device is a bolted connection, a bayonet joint, or a snap-in connection. Connections of this type are known, inter alia, from oil filters which are utilized as easy-change filters in vehicle manufacturing. The connection, according to the present invention, of a deionization device to the cooling circuit of a fuel cell unit via only one connection unit and, in particular, the use of flanges designed as a bolted connection, a bayonet joint, or a snap-in connection provide the advantage that a deionization device may be designed as an easy-change filter. In the manufacture of a deionization device according to the present invention, a so-called identical part effect therefore results with respect to known easy-change filters, in particular oil filters for internal combustion engines; this means that already available components (for example, a housing or connection elements) may be utilized for different purposes.

It is further preferred when the connection unit includes an active or passive closure mechanism for closing and opening the flow inlet and the flow outlet of the deionization device. This makes it possible to remove the deionization device without first removing the coolant from the cooling circuit. In particular, the closure mechanism is designed in such a way that the coolant may continue to flow in the cooling circuit. The closure mechanism is advantageously designed as a check (passive) valve or a controllable (active) valve.

The housing is further designed in such a way that the housing is able to accommodate a deionizing agent. In one preferred embodiment, the deionizing agent is situated, as a filling, within the deionization device in such a way that the coolant flowing therethrough flows around the deionizing agent. This has the advantage that a preferably large surface of the deionizing agent comes into contact with the inflowing coolant. During the contact, the coolant is deionized via a chemical reaction with the deionizing agent and re-enters the cooling circuit as deionized coolant.

Furthermore, it is preferred that the deionizing agent is present in the solid state, in particular as an ion exchange resin. Solid deionizing agents offer the advantage that the solid deionizing agents are easily exchangeable and do not mix with the coolant.

In yet another preferred embodiment of the present invention it is provided that the deionization device further includes a permeable filter element which is situated within the housing and separates the deionizing agent from the flow outlet of the deionization device. A filter element situated in this way offers the advantage of ensuring that no deionizing agent enters the cooling circuit and, in addition, solid components such as, for example, corrosion particles, insoluble salts or algae are retained from the coolant. In the case of a hollow- cylindrical housing, in particular, the filter element is preferably designed as a tube element which is coaxially situated in the hollow cylinder and has a perforation or is formed from a mesh.

Particularly advantageously, the coolant includes water, an antifreeze fluid, and at least one corrosion inhibitor. During the operation of fuel cells, a relatively large amount of heat is dissipated despite a low temperature difference with respect to the ambient temperature, and therefore liquid coolants which have a sufficiently high heat capacity are utilized. Aqueous coolants are therefore very highly suitable. The addition of the non-ionic, in particular, corrosion inhibitor protects the cooling circuit and the fuel cell against corrosion. Ethylene glycol, for example, may be utilized as an antifreeze fluid. Furthermore, the coolant may contain other additives.

A further aspect of the present invention is a method for maintaining a deionization device in a fuel cell unit according to the present invention, which includes a cooling circuit and a fuel cell. According to the present invention, the deionization device is disconnected from the connection unit and, therefore, from the cooling circuit and is replaced by a further deionization device which is connected to the cooling circuit via the same connection unit. This method offers the advantage, on the one hand, that the exchange of deionizing agent situated within the deionization device is substantially simplified, since the entire deionization device is removed and is replaced by a fresh deionization device which likewise contains fresh, i.e., active, deionizing agent. Therefore, the user does not come into direct contact with the deionizing agent, so that complex handling and the corresponding safety equipment for avoiding dangers are dispensed with. The same applies for the disposal, since the deionization device may be disposed of in its entirety and, therefore, the deionizing agent does not come into contact with the surroundings even during storage in the waste container.

Yet another aspect of the present invention relates to a vehicle which includes a fuel cell unit in one of the described embodiments.

Further preferred embodiments of the present invention result from the remaining features mentioned in the subclaims.

The different specific embodiments of the present invention mentioned in this application may be advantageously combined with each other unless stated otherwise in an individual case.

### BRIEF DESCRIPTION OF THE DRAWINGS

The present invention is described in the following in exemplary embodiments with reference to the associated drawings.

FIG. 1A shows a schematic representation of a fuel cell unit according to the prior art,

FIG. 1B shows a schematic sectional representation of a deionization device according to the prior art,

FIG. 2A shows a schematic representation of a fuel cell unit according to the present invention, and

FIG. 2B shows a schematic sectional representation of a deionization device according to the present invention.

### DETAILED DESCRIPTION

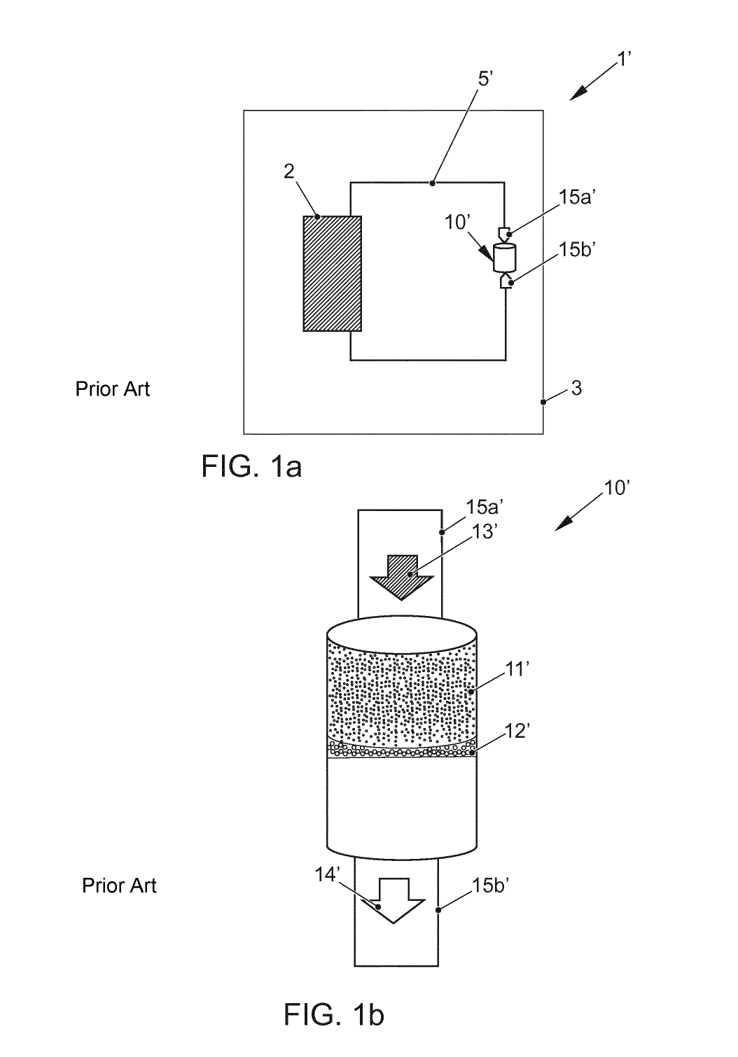

FIG. 1A shows a schematic representation of a fuel cell unit 1′ according to the prior art. Fuel cell unit 1′ includes a fuel cell 2 which, for example, is the energy source for an electric vehicle indicated by reference numeral 3.

Fuel cell 2 is cooled by a cooling circuit 5′. Cooling circuit 5′ includes a deionization device 10′ which is connected in a fluid-conveying manner upstream and downstream to cooling circuit 5′ with the aid of a connection unit 15a′, 15b′, respectively. Connection units 15a′ and 15b′ each establish a disconnectable and fluid-conveying connection between deionization device 10′ and cooling circuit 5′. Deionization device 10′ is used for deionizing the coolant and is represented in detail in FIG. 1B.

FIG. 1B shows a deionization device 10′ according to the prior art, which is used in a conventional fuel cell unit 1′ from FIG. 1A. Deionization device 10′ includes a housing 16′ which is tubular, for example, and extends along the flow direction. In the represented specific embodiment, the housing has a round cross section. One connection unit 15a′, 15b′ is situated at each of the resultant end faces of deionization device 10′. Housing 16′ is situated in cooling circuit 5′ in such a way that a first connection unit 15a′ is connected upstream to cooling circuit 5′ and therefore forms flow inlet 13′, while the second, opposite connection unit 15b′ is connected downstream to cooling circuit 5′ and therefore forms flow outlet 14′. Connection units 15a′, 15b′ are designed approximately as tube connections, in order to connect housing 16′ to a line of cooling circuit 15′. Housing 16′ of deionization device 10′ accommodates a deionizing agent 11′. In this case, deionizing agent 11′ is present, for example, as a filling in solid form, in particular as granulate material. In addition, a filter element 12′ having a retaining function is situated in the interior of housing 16′. Filter element 12′ delimits the space of deionizing agent 11′ in such a way that only one side of filter element 12′ is in contact with deionizing agent 11′. In the present embodiment, filter element 12′ is designed as a sieve which has a shape corresponding to the cross section of housing 16′ of deionization device 10′.

Deionization device 10′ according to the prior art, which is represented in FIG. 1B, shows, in the represented embodiment during operation, the function of liquid coolant at flow inlet 13′ being introduced into deionization device 10′ from cooling circuit 5′ via connection unit 15a′. In the interior of deionization device 10′, the introduced coolant flows around deionizing agent 11′ situated therein. In this case, ions dissolved in the coolant are taken up by deionizing agent 11 by way of chemical exchange reactions, deionizing agent 11, in turn, giving off equivalent amounts of hydrogen ions H⁺ and hydroxide ions OH⁻ to the coolant. Hydrogen ions and hydroxide ions recombine to form water, depending on the pH value of the coolant. The coolant passes through filter element 12′ before the coolant emerges from deionization device 10′ on the opposite side of the housing. Filter unit 12′ has the function of retaining deionizing agent and solid components in the coolant and, therefore, of preventing solid components from entering cooling circuit 5′. At flow outlet 14′, the coolant is directed out of deionization device 10′ and back into cooling circuit 5′ via connection unit 15b′. Due to having flowed through deionization device 10′, the coolant circulating in cooling circuit 5′ is deionized; this means the coolant has a lower conductance value downstream from deionization device 10′ than upstream from deionization device 10′.

As is apparent in FIGS. 1A and 1B, connection units 15a′ and 15b′ of conventional deionization device 10′ are located on different, in particular opposite, sides of housing 16′.

In order to regenerate deionizing agent 11″, deionization device 10′ is removed from cooling circuit 5′ by disconnecting the connections to the two connection units 15′. Prior thereto, the coolant is drained from cooling circuit 5′ or blocked upstream and downstream from deionization device 10′. After deionization device 10′ is removed, the deionization device is opened and spent deionizing agent 11′ is replaced by fresh deionizing agent. It must be noted in this case that deionizing agent 11′ is classified, for health reasons, as an irritant. Refilled deionization device 10′ is subsequently reinstalled in the cooling circuit and the fluid connection to the coolant is re-established.

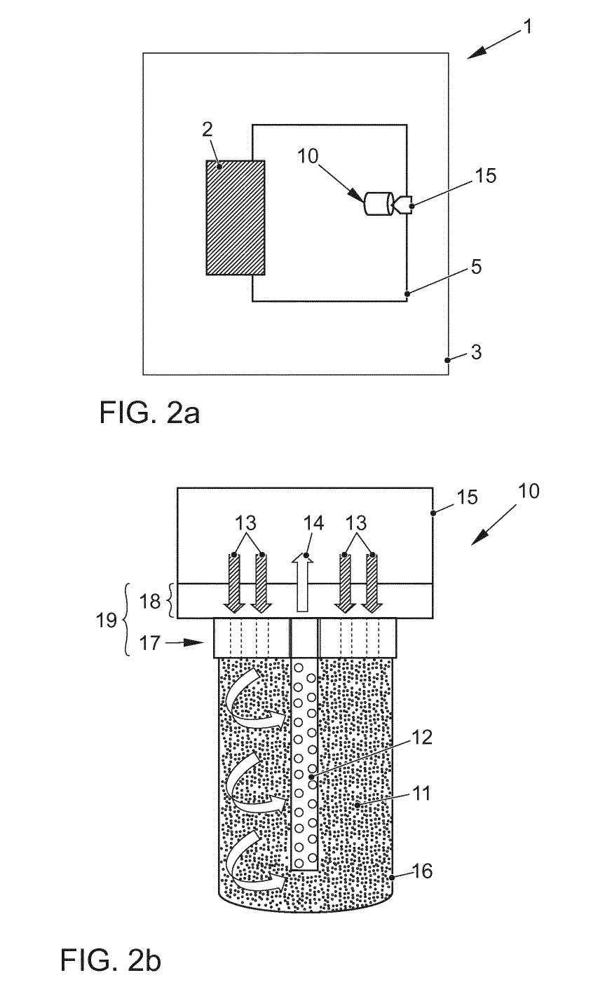

FIG. 2A shows the schematic representation of a fuel cell unit 1 according to the present invention. In this case, functionally identical components are labeled using the same reference numerals as in FIGS. 1A and 1B, although without the apostrophe “'”.

Fuel cell unit 1 according to the present invention includes a cooling circuit 5 which is designed for cooling a fuel cell 2, for example, of an electric vehicle 3. A fluid, in particular liquid coolant for cooling fuel, may circulate within cooling circuit 5. In order to cool fuel cell 2, aqueous coolants are used, in particular, which contain an antifreeze fluid, for example, glycol, and a non-ionic corrosion inhibitor as additives.

Cooling circuit 5 includes a connection unit 15 according to the present invention. Connection unit 15 is connected to cooling circuit 5 at two points and, at a further position, is connected to a deionization device 10 according to the present invention. Deionization device 10 is therefore connected to a line system of cooling circuit 5 with the aid of only a single connection unit 15. The connections are designed to be fluid-conveying, so that connection unit 15 represents a branch-off of the coolant from cooling circuit 5 into deionization device 10 and out of deionization device 10 into cooling circuit 5. A disconnectable connection is present between deionization device 10 and connection unit 15. This disconnectable connection is designed, in particular, as a flange or a thread. Flanges having a plug connection, a snap-in connection, or a bayonet joint are very highly suitable in this case. Deionization device 10 is represented in detail in FIG. 2B.

FIG. 2B shows deionization device 10 according to the present invention, which is suitable for installation in a fuel cell unit 1 according to FIG. 2A. The specific embodiment of a deionization device 10 according to the present invention, which is shown in FIG. 2B, shows a deionization device 10 which is designed similarly to an oil-change filter. The deionization device includes a filter pot 16 which forms the housing of deionization device 10. Filter pot 16 is designed as a vessel which is open on one side. The filter pot includes a lateral wall and at least one end wall (at the bottom in FIG. 2B), the end wall having a circular shape in the specific embodiment shown; this means the filter pot essentially has the shape of a hollow cylinder which is open on one side. Filter pot 16 extends lengthwise in this case, so that the diameter of the end wall is smaller than the height of the lateral wall. It is understood, however, that other embodiments are also possible. A connection piece 17 is situated on the open end face of filter pot 16, which is situated opposite the end wall. This connection piece 17 corresponds to a connection end 18 of connection unit 15. Connection piece 17 of filter pot 16 and connection end 18 of connection unit 15 form a flange connection 19 which forms a fluid-conveying, outwardly sealing connection for coolant. Fluid-conveying flange connection 19 includes both a flow inlet 13 and, decoupled therefrom, a flow outlet 14. In other words, flow inlet 13 and flow outlet 14 are integrated in connection piece 17 of deionization device 10. Flow inlet 13 and flow outlet 14 are therefore situated on the same side of the housing (filter pot 16) of deionization device 10.

Filter pot 16 is filled with a deionizing agent 11. In the specific embodiment shown, deionizing agent 11 is present as a filling made up of an ion exchange resin granulate. The individual granules of the granulate material preferably have a diameter of less than one millimeter. In addition, a filter element 12 is situated in the interior of filter pot 16. Filter element 12 may be designed as a sieve, the mesh size of which is less than the grain diameter of deionizing agent 11. In the specific embodiment shown, filter element 12 is designed as a lengthwise-extending and perforated trap pipe and is situated coaxially within filter pot 16 and is connected to flow outlet 14.

If deionization device 10 shown in FIG. 2B is installed in cooling circuit 5 of a fuel cell unit 1, coolant is conveyed from cooling circuit 5 in the area of connection unit 15 into the interior of deionization device 10 via flow inlet 13. Here, the coolant flows around deionizing agent 11. The coolant, which is continuously pressed into the interior of filter pot 16 via flow inlet 13, undergoes a flow reversal in the interior of deionization device 10 and is conveyed through filter element 12 in the direction of flow outlet 14. From there, the coolant re-enters cooling circuit 5 via connection unit 15, downstream therefrom.

When the coolant flows around deionizing agent 11, an ion exchange takes place; this means ions, which increase the conductivity of the coolant, are exchanged via chemical pathways, by the material of deionizing agent 11, for protons (in the case of cations) or hydroxide ions (in the case of anions). After a certain duration of operation, deionizing agents 11 exhibit a saturation with ions to be exchanged. The deionizing agents must therefore be replaced and, if necessary, regenerated. In the case of deionization device 10 according to the present invention, the replacement or exchange of deionizing agent 11 takes place by exchanging entire deionization device 10. For this purpose, the coolant flow is initially interrupted at least in the area of connection unit 15. This may be carried out, for example, with the aid of a closure mechanism within connection unit 15. The sealing connection between connection piece 17 and connection end 18 is subsequently disconnected and the unit formed from filter pot 16, deionizing agent 11, filter element 12, and connection piece 17 are removed from fuel cell unit 1. Subsequently, a fresh deionization device 10, which has at least one compatible connection piece 17, is sealingly connected to connection end 18 of connection unit 15 in a way similar to that of previously removed deionization device 10. The dimensions of filter pot 16 and, therefore, the amount of deionizing agent 11, may be varied during the exchange.

### LIST OF REFERENCE NUMERALS

1 Fuel cell unit
1′ Fuel cell unit according to the prior art
2 Fuel cell
3 Electric vehicle
3′ Electric vehicle according to the prior art
5 Cooling circuit
5′ Cooling circuit according to the prior art
10 Deionization device
10′ Deionization device according to the prior art
11 Deionizing agent
11′ Deionizing agent
12 Filter element
12′ Filter element according to the prior art
13 Flow inlet
13′ Flow inlet according to the prior art
14 Flow outlet
14′ Flow outlet according to the prior art
15 Connection unit
15′ Connection unit according to the prior art
16 Housing/Filter pot
16′ Housing according to the prior art
17 Connection piece
18 Connection end
19 Connection/Flange

1-10. (canceled)

11. A fuel cell unit comprising:
at least one fuel cell;
a cooling circuit; and
a deionization device including a housing and a deionizing agent situated in the housing, the deionization device connectable or connected to the cooling circuit in a fluid-conveying manner via a flow inlet and a flow outlet with the aid of a single connection unit.

12. The fuel cell unit as recited in claim 11 wherein the flow inlet and the flow outlet are for a coolant and are situated on a same side of the housing of the deionization device.

13. The fuel cell unit as recited in claim 11 wherein the housing of the deionization device is designed as a vessel open on one side, and is connectable or connected to the connection unit via the open side.

14. The fuel cell unit as recited in claim 11 wherein a connection between the connection unit and the deionization device is designed as a plug connection or a rotary joint.

15. The fuel cell unit as recited in claim 14 wherein the connection between the connection unit and the deionization device is designed as a bolted connection, a bayonet joint, or a snap-in connection.

16. The fuel cell unit as recited in claim 11 wherein the connection unit includes an active or passive closure mechanism for closing and opening the flow inlet and the flow outlet of the deionization device.

17. The fuel cell unit as recited in claim 11 wherein the deionizing agent is a filling made up of an ion exchange resin, a coolant flowable around the ion exchange resin.

18. The fuel cell unit as recited claim 11 wherein the deionization device further includes a permeable filter element situated within the housing and separating the deionizing agent from the flow outlet.

19. The fuel cell unit as recited in claim 11 wherein a coolant of the cooling circuit includes water, an antifreeze fluid, and at least one corrosion inhibitor.

20. A vehicle comprising the fuel cell unit as recited in claim 11.
